(19) United States
(12) Patent Application Publication
(10) Pub. No.: US 2017/0232816 A1
(43) Pub. Date: Aug. 17, 2017

(54) AIR CONDITIONING SYSTEM OF A MOTOR VEHICLE

(71) Applicant: Mahle International GmbH, Stuttgart (DE)

(72) Inventors: Philipp Kullen, Stuttgart (DE); Thorsten Moellert, Stuttgart (DE); Michael Sickelmann, Kornwestheim (DE); Vincenzo Venezia, Weil Im Schoenbuch (IT)

(21) Appl. No.: 15/435,267

(22) Filed: Feb. 16, 2017

(30) Foreign Application Priority Data
Feb. 17, 2016 (DE) 10 2016 202 445.0

(51) Int. Cl. B60H 1/00; B60H 1/32; B60H 1/22

(52) U.S. Cl. CPC B60H 1/00064; B60H 1/2225; B60H 1/3204; B60H 2001/00164; B60H 2001/00128

(57) ABSTRACT

An air-conditioning system of a motor vehicle may include a fan, an evaporator, and at least one heat exchanger. The evaporator may be arranged downstream of the heat exchanger and may both be arranged in a housing. An air-conditioning system may also include a first bypass duct that bypasses the heat exchanger and a first flap arranged within the first bypass duct. The heat exchanger may be able to be switched off and may be able to be regulated with regard to a heat output of the heat exchanger.

### CROSS-REFERENCE TO RELATED APPLICATIONS

This application claims priority to German Patent Application No. 10 2016 202 445.0, filed Feb. 17, 2016, the contents of which are hereby incorporated by reference in its entirety.

### TECHNICAL FIELD

The present invention relates to an air-conditioning system of a motor vehicle, having a fan, an evaporator and at least one heat exchanger arranged downstream thereof The invention furthermore relates to a motor vehicle having such an air-conditioning system.

### BACKGROUND

DE 10 2004 026 478 A1 discloses a generic air-conditioning system of a motor vehicle, having a fan and an evaporator, wherein a heat exchanger is arranged downstream of the evaporator. This heat exchanger is in this case bypassed by a first bypass duct, wherein a first flap is arranged in this first bypass duct. The heat exchanger is in this case flowed through by a heat transport medium.

DE 198 35 286 B4 likewise discloses an air-conditioning system of a motor vehicle, having an air guide housing and at least one heat exchanger, arranged in the housing, for heating air. In this case, this heat exchanger projects at least partially into two adjacent air ducts, which are connected together at one end such that the air flowing through the first air duct is heatable for a first time by the heat exchanger and, upon subsequently flowing through the second air duct, can be heated for a second time. As a result, heating or air-conditioning of the motor vehicle in separate zones is intended to be possible.

DE 103 15 733 A1 discloses an apparatus for the exchange and input of heat, having a feed device which additionally comprises a heating device for heating at least a part of a gaseous medium and at least one arm arranged downstream of the heating device in the direction of flow of the gaseous medium. At least two ducts for the gaseous medium that proceed from the space lead in this case into at least two air-conditioning zones of the interior of the motor vehicle. In this case, a regulating device is provided in at least one of the ducts, said regulating device regulating the amount of medium flowing through the duct. The heating device has at least two through-flow devices for a second medium, wherein at least two of these through -flow devices have different designs. As a result, an apparatus for the individual air-conditioning of separate regions in a motor vehicle interior is intended to be created.

DE 103 14 017 B3 likewise discloses an air-conditioning system for a passenger compartment of a motor vehicle, which comprises a fan for creating an air flow and a heat exchanger arranged in the air flow, said heat exchanger being flowed through by a heat transfer medium. In order to increase the heating comfort, a regulating device is provided which, with the fan switched off, can regulate the temperature of the heat transfer medium flowing through the heat exchanger to a predetermined value. As a result, in particular increased comfort demands are intended to be able to be satisfied.

In order to be able to maximize the efficiency of current air-conditioning systems, the aim is to use only as much energy for cooling and heating in each particular air-conditioning system as is actually required to achieve or maintain the climatic comfort in the vehicle cab. As a result, unnecessary consumption of electrical energy, which can result in a significant reduction of the range in particular in electric vehicles, is intended to be avoided.

Generally, two different air-conditioning concepts are specified for this purpose, namely what is known as a “water-side” regulating concept, in which individual heat exchangers can be regulated in sections such that the temperature of the air flowing out of the heat exchanger into the various zones of the air-conditioning system can be controlled differently. Provided for this purpose is in particular a separate flap that is provided in particular for adding cold air. In the case of an unregulated heat source, the mixing temperature per zone has to be set via the individual mass flows of cold and hot air, this corresponding to what is known as the “air-side” regulating concept.

In the case of a regulatable heat exchanger, it is disadvantageous for example that a separate regulatable heat exchanger is required per temperature zone. However, such components that are to be operated partially are usually very expensive and in addition often have an increased installation space requirement. In the case of unregulated heat exchangers, although only a single common heat source is used, a separate temperature mixing flap, or generally a flap, is required for each temperature zone, and so this mixing concept likewise has an increased installation space requirement. During “maximum cooling” operation, the air path through the heat exchanger additionally has to be closed, and so only the “cold path” bypass can be used to guide the flow, with the result that the pressure loss and noise level rise.

### SUMMARY

Therefore, the present invention deals with the problem of specifying an improved or at least an alternative embodiment for an air-conditioning system of the generic type, said embodiment overcoming the disadvantages known from the prior art.

This problem is solved according to the invention by the subject matter of independent Claim(s). Advantageous embodiments are the subject matter of the dependent claims.

The present invention is based on the general idea of using, for the first time in an air-conditioning system known per se, a heat exchanger which is able to be switched off and in particular is able to be regulated with regard to its heat output. The air-conditioning system according to the invention in this case has a fan and also an evaporator and at least one heat exchanger arranged downstream thereof, wherein both the evaporator and the heat exchanger are arranged in the housing. The heat exchanger is in this case able to be bypassed by a first bypass duct, wherein a first flap is arranged in this first bypass duct. According to the invention, the heat exchanger is now able to be switched off, with the result that the desired blowing temperature(s) and the temperature layers can be set at the air-conditioning system by means of mixing “cold” and “hot” air, and the temperature level of the hot air can be set separately via the heat exchanger. Given different temperature demands of individual zones, the heat exchanger provides the heat required for the highest demand (water-side regulating concept). In the zones with a lower temperature demand, this is set by mixing cold and hot air (air-side regulating concept). This results in the hybrid mixing concept according to the invention. A particular advantage here is that in “maximum cooling” operation, the heat exchanger can be switched off completely, and so the entire flow cross section, i.e. both the hot path through the heat exchanger and the cold path through the first bypass duct can be used for air guidance. As a result, not only is the pressure loss reduced, but also the noise level, this proving to be a significant advantage in particular in electric vehicles. A further significant advantage of the air-conditioning system according to the invention is that the heat exchanger is not only flowed through partially by air, but is flowed through completely by air in all operating states, with the result that the previously occurring deficits in the temperature profile within the heat exchanger can be completely avoided. As a result, it is possible in particular also to use simple and cost-effective heat exchangers. Compared with a regulatable heat exchanger, a heat exchanger that is merely able to be switched off is additionally more cost-effective. Of course, a heat exchanger that is able to be switched off and is able to be regulated with regard to its heat output is also conceivable. The temperature of the air-conditioning system outputs can also be regulated via a combination of the position of the first flap in the first bypass duct and the heat-exchanger temperature, that is to say the regulation of the heat output of the heat exchanger, in a hybrid system that operates in a very energy-efficient manner. In such a case, the heat exchanger is thus not only able to be switched off but is also regulatable.

In an advantageous development of the solution according to the invention, a mixing space is arranged downstream of the heat exchanger, wherein a third flap is arranged between the heat exchanger and the mixing space. In the mixing space, homogenization of the individual partial air flows, coming from the heat exchanger and the first bypass duct, can be achieved, wherein at least two air distribution ducts branch off from this mixing space, the air flow through said air distribution ducts being controllable in each case with a separate flap. If there is a relatively small ventilation requirement, the heat exchanger can be closed completely via the third flap, such that all of the air flows through the first bypass duct. If the amount of air is intended to be increased with a simultaneously low temperature, the third flap can be opened such that it is now possible for the heat exchanger also to be flowed through completely. If the latter is switched off, the air flowing through it is not heated.

In a further advantageous embodiment of the solution according to the invention, the air-conditioning system has at least two zones downstream of the evaporator that are separated from one another. In this case, the heat exchanger extends over both zones, wherein a separate bypass duct that bypasses the heat exchanger and has a separate flap is additionally provided in each zone. Thus, the first bypass duct bypasses the heat exchanger in the first zone, while a second bypass duct bypasses the heat exchanger in the second zone, wherein a second flap is now arranged in the second bypass duct. If air at a much higher temperature level is intended to be output for example in the second zone, the second bypass flap is closed such that all of the air flows through the heat exchanger in the second zone. In the first zone, in which for example air at a lower temperature level is intended to be output, the first bypass flap can be at least partially opened, with the result that air-side regulation takes place. Purely theoretically, it is of course also possible for more than the abovementioned two zones to be present, wherein each zone has a separate bypass duct, bypassing the respective heat exchanger, and a separate flap, arranged in the respective bypass duct, for regulating the mass flow flowing through the bypass duct. Preferably, the heat exchanger is connected to a cooling circuit, in particular to a cooling circuit of an internal combustion engine. Theoretically, the heat exchanger can of course also be electrically operated. As a result of the regulation concept according to the invention with the heat exchanger that is able to be switched off, a hybrid concept made up of the air-side and the water-side regulation concept can thus be created, said hybrid concept, in particular in an operating state in which a maximum cooling performance is required, making the entire flow cross section available for throughflow, that is to say including the flow cross section of the heat exchanger, since the latter can simply be switched off in this case.

Further important features and advantages of the invention can be gathered from the dependent claims, from the drawings, and from the associated description of the figures with reference to the drawings.

It goes without saying that the features mentioned above and those yet to be explained below are usable not only in the combination specified in each case but also in other combinations or on their own without departing from the scope of the present invention.

Preferred exemplary embodiments of the invention are illustrated in the drawings and described in more detail in the following description, wherein identical reference signs relate to identical or similar or functionally similar components.

### BRIEF DESCRIPTION OF THE DRAWINGS

In the drawings, in each case schematically,

FIG. 1 shows a sectional illustration through an air-conditioning system according to the invention,

FIG. 2 shows a sectional illustration of the air-conditioning system according to the invention with a horizontal section plane and two zones.

### DETAILED DESCRIPTION

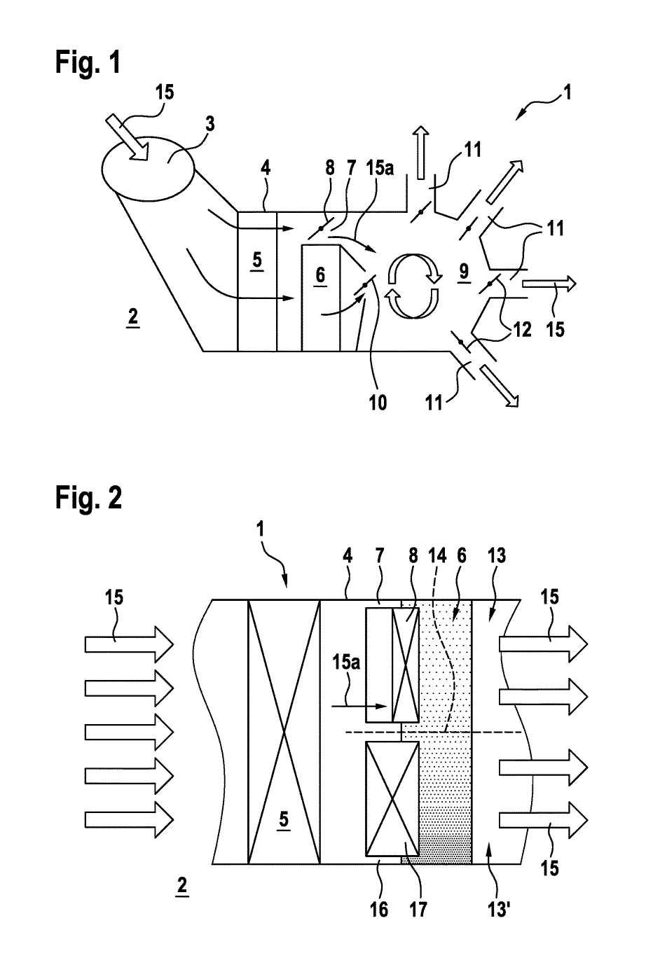

According to FIG. 1, an air-conditioning system 1 according to the invention of a motor vehicle 2 (not otherwise illustrated) has a fan 3 and a housing 4 in which an evaporator 5 and a heat exchanger 6, downstream of the latter, are arranged. Likewise provided is a first bypass duct 7 which bypasses the heat exchanger 6 and in which a first flap 8 is arranged. This flap 8 is a throttle flap which, in the closed state, can completely close the cross section of the bypass duct 7. According to the invention, the heat exchanger 6 is now able to be switched off and in particular is able to be regulated with regard to its heat output. This provides the particular advantage that, for an operating state in which maximum cooling is desired, the entire flow cross section of the bypass duct 7 and also of the heat exchanger 6 is available, since the latter can in this case simply be switched off and therefore does not heat the air flowing through it.

If the heat exchanger 6 is not only able to be switched off but also able to be regulated with regard to its heat output, temperature regulation of the air-conditioning outlets can also take place via a combination of the position of the first flap 8 in the first bypass duct 7 and the heat output of the heat exchanger 6 in a hybrid system that operates in a very energy-efficient manner.

Arranged downstream of the heat exchanger 6 is a mixing space 9. A third flap 10 can be arranged in this case between the heat exchanger 6 and this mixing space 9. This third flap 10 makes it possible to completely prevent an air flow through the heat exchanger 6, such that if, for example, only a small cooling output is required, the flap 10 can be closed and as a result the heat exchanger 6 can be closed off, wherein, in this case, the entire air flow flows through the first bypass duct 7. From the mixing space 9, at least two air distribution ducts 11, in this case a total of four air distribution ducts 11, branch off, which are each controllable, that is to say are able to be shut off, with a separate flap 12. By way of the individual air distribution ducts 11, it is in particular possible to air-condition individual regions of the passenger compartment of the motor vehicle 2.

In general, it is also conceivable for the air-conditioning system 1 to be configured as a multizone air-conditioning system and accordingly to have at least two zones 13, 13′ downstream of the evaporator 5 that are separated from one another, as can be clearly seen in FIG. 2. The two zones 13, 13′ are in this case separated from one another by a partition wall 14. The air flow 15 flowing through the air-conditioning system 1 thus first of all flows through the evaporator 5 and is cooled in the latter, wherein it is divided between the two zones 13 and 13′ downstream of the evaporator 5. In this case, the heat exchanger 6 extends over both zones 13, 13′ according to FIG. 2. In this case, the first bypass duct 7, bypassing the heat exchanger 6, is arranged in the first zone 13, while a second bypass duct 16 bypasses the heat exchanger 6 in the second zone 13′, wherein a second flap 17 is arranged in the second bypass duct 16. In this case, the heat exchanger 6 can be connected to a cooling circuit, in particular of an internal combustion engine, but, purely theoretically, can also be electrically operated and as a result not only be able to be switched off but also to be regulated with regard to its heat output.

By way of the multizone air-conditioning system 1 shown in FIG. 2, it is in particular possible to realize a much higher temperature level of the air flow 15 in the second zone 13′ than in the first zone 13. To this end, for example the second flap 17 is closed such that all of the air flow 15 flowing through the second zone 13′ flows through the heat exchanger 6 and is heated there in a corresponding manner. If a lower temperature level is intended to be set in the first zone 13, the first flap 8 in the first bypass duct 7 is opened at least slightly, with the result that a partial air flow 15a flows through the first bypass duct 7 and thus bypasses the heat exchanger 6, such that the emerging air flow 15 is cooler. If maximum cooling in both zones 13, 13′ is intended to be achieved, the heat exchanger 6 is not just turned down with regard to its heat output, but is switched off entirely, such that, in this case, the air flow 15 can flow both through the first bypass duct 7 as an air flow 15a and through the second bypass duct 16 and at the same time through the heat exchanger 6 that is present in both zones 13, 13′ but switched off. As a result, a comparatively cost-effective component can be selected for the heat exchanger 6. Furthermore, deficits in the temperature profile within the heat exchanger 6, which result from partial air throughflow, are avoided, since the heat exchanger 6 is flowed through completely by air in all operating states. By way of the heat exchanger 6 that is able to be switched off and in particular able to be regulated with regard to its heat output, an additional degree of freedom for regulating the exit temperature results.

The air-conditioning system 1 according to the invention thus employs a hybrid concept, specifically a mixture of the water-side and the air-side regulating concept, wherein, given different temperature demands of individual zones 13, 13′, the heat exchanger 6 provides the heat output required for the highest demand (water-side regulating concept) and wherein, in the zone 13 with a lower temperature demand, this is set by mixing cold and hot air (air-side regulating concept). As a result of it being possible to completely switch off the heat exchanger 6, it is possible for the latter also to be completely flowed through in the event of maximum desired cooling, with the result that the pressure loss and the noise level can be lowered.

1. An air-conditioning system of a motor vehicle, comprising:
a fan;
an evaporator and at least one heat exchanger arranged downstream thereof, the evaporator and the heat exchanger being arranged in a housing;
a first bypass duct that bypasses the heat exchanger; and
a first flap arranged within the first bypass duct;
wherein the heat exchanger is able to be switched off and is able to be regulated with regard to a heat output of the heat exchanger.

2. The air-conditioning system according to claim 1, further comprising:
a mixing space arranged downstream of the heat exchanger; and
an additional flap arranged between the heat exchanger and the mixing space.

3. The air-conditioning system according to claim 2, wherein at least two air distribution ducts branch off from the mixing space, the at least two air distribution ducts each being controllable with a separate flap.

4. The air-conditioning system according to claim 1, further comprising at least two zones downstream of the evaporator that are separated from one another.

5. The air-conditioning system according to claim 4, wherein the heat exchanger extends over the at least two zones.

6. The air-conditioning system according to claim 4, wherein:
the first bypass duct bypasses the heat exchanger in a first zone of the at least two zones;
a second bypass duct bypasses the heat exchanger in a second zone of the at least two zones; and
a second flap is arranged in the second bypass duct.

7. The air-conditioning system according to claim 1, wherein one of:
the heat exchanger is connected to a cooling circuit; or
the heat exchanger is electrically operated.

8. A motor vehicle comprising an air-conditioning system, having:
a fan;
an evaporator and at least one heat exchanger arranged downstream thereof, the evaporator and the heat exchanger being arranged in a housing;
a first bypass duct that bypasses the heat exchanger; and
a first flap arranged within the first bypass duct;
wherein the heat exchanger is able to be switched off and is able to be regulated with regard to a heat output of the heat exchanger.

9. The motor vehicle according to claim 8, wherein the air-conditioning system includes:
a mixing space arranged downstream of the heat exchanger; and
an additional flap arranged between the heat exchanger and the mixing space.

10. The motor vehicle according to claim 9, wherein the air-conditioning system includes at least two air distribution ducts that branch off from the mixing space, the at least two air distribution ducts each being controllable with a separate flap.

11. The motor vehicle according to claim 8, wherein the air-conditioning system includes at least two zones downstream of the evaporator that are separated from one another.

12. The motor vehicle according to claim 11, wherein the heat exchanger extends over the at least two zones.

13. The motor vehicle according to claim 11, wherein:
the first bypass duct bypasses the heat exchanger in a first zone of the at least two zones;
a second bypass duct bypasses the heat exchanger in a second zone of the at least two zones; and
a second flap is arranged in the second bypass duct.

14. The motor vehicle according to claim 8, wherein one of:
the heat exchanger is connected to a cooling circuit; or
the heat exchanger is electrically operated.

15. A motor vehicle air-conditioning system, comprising:
a fan;
an evaporator and at least one heat exchanger arranged downstream thereof, the evaporator and the heat exchanger being arranged in a housing;
a mixing space arranged downstream of the heat exchanger;
a first bypass duct that bypasses the heat exchanger; and
a first flap arranged within the first bypass duct;
wherein the heat exchanger is connected to a cooling circuit;
wherein the heat exchanger is able to be switched off and is able to be regulated with regard to its heat output; and
wherein an additional flap is arranged between the heat exchanger and the mixing space.

16. The motor vehicle air-conditioning system according to claim 15, wherein at least two air distribution ducts branch off from the mixing space, the at least two air distribution ducts each being controllable with a separate flap.

17. The motor vehicle air-conditioning system according to 16, further comprising at least two zones downstream of the evaporator that are separated from one another.

18. The motor vehicle air-conditioning system according to claim 15, further comprising at least two zones downstream of the evaporator that are separated from one another.

19. The motor vehicle air-conditioning system according to claim 18, wherein the heat exchanger extends over that at least two zones.

20. The motor vehicle air-conditioning system according to claim 18, wherein:
the first bypass duct bypasses the heat exchanger in a first zone of the at least two zones;
a second bypass duct bypasses the heat exchanger in a second zone of the at least two zones; and
a second flap is arranged in the second bypass duct.
